(19) United States
(12) Patent Application Publication
(10) Pub. No.: US 2014/0348529 A1
(43) Pub. Date: Nov. 27, 2014

(54) CLEANING DEVICE, IMAGE FORMING APPARATUS, AND CLEANING METHOD

(71) Applicant: KYOCERA Document Solutions Inc., Osaka (JP)

(72) Inventors: Hiroki Takahashi, Osaka (JP); Daisuke Fujiwara, Osaka (JP)

(73) Assignee: KYOCERA Document Solutions Inc., Osaka (JP)

(21) Appl. No.: 14/278,347

(22) Filed: May 15, 2014

(30) Foreign Application Priority Data
May 23, 2013 (JP) 2013-108838

(51) Int. Cl. G03G 15/00

(52) U.S. Cl. CPC G03G 21/00
USPC 399/71

(57) ABSTRACT

A cleaning device is provided in an image forming apparatus, and cleans an object to be cleaned. The cleaning device includes a cleaning member, a cleaning mechanism, a motor, a cleaning control portion, and a driving change portion. The cleaning member slides along the object to be cleaned. The cleaning mechanism causes the cleaning member to slide along the object to be cleaned. The motor drives the cleaning mechanism. The cleaning control portion drives the motor with a predetermined driving voltage being applied to the motor, and stops the driving of the motor after a predetermined driving time has elapsed. The driving change portion is able to change one or both of the driving time and the driving voltage.

### INCORPORATION BY REFERENCE

This application is based upon and claims the benefit of priority from the corresponding Japanese Patent Application No. 2013-108838 filed on May 23, 2013, the entire contents of which are incorporated herein by reference.

### BACKGROUND

The present disclosure relates to a cleaning device including a cleaning mechanism that cleans an object to be cleaned by moving a cleaning member along the object to be cleaned, and an image forming apparatus including the cleaning device.

An electrophotographic type image forming apparatus is equipped with a laser scanning unit that irradiates a photosensitive drum with light to form an electrostatic latent image. At an outer surface of a housing of the laser scanning unit, a light emitting window through which the light is emitted toward the photosensitive drum is provided. Meanwhile, a cleaning mechanism has been known which cleans the light emitting window of the laser scanning unit by moving a cleaning member in contact with the light emitting window. When a motor is used as a drive source for the cleaning mechanism, if the position of the cleaning member is controlled by driving the motor for a predetermined driving time, it is possible to dispense with a sensor for detecting the position of the cleaning member.

### SUMMARY

A cleaning device according to an aspect of the present disclosure is provided in an image forming apparatus, and cleans an object to be cleaned. The cleaning device includes a cleaning member, a cleaning mechanism, a motor, a cleaning control portion, and a driving change portion. The cleaning member slides along the object to be cleaned. The cleaning mechanism causes the cleaning member to slide along the object to be cleaned. The motor drives the cleaning mechanism. The cleaning control portion drives the motor with a predetermined driving voltage being applied to the motor, and stops the driving of the motor after a predetermined driving time has elapsed. The driving change portion is able to change one or both of the driving time and the driving voltage.

An image forming apparatus according to another aspect of the present disclosure includes the cleaning device, and a laser scanning unit that emits light to a photosensitive drum through a light emitting window provided at an outer surface of a housing and having transparency. The object to be cleaned is the light emitting window.

An image forming apparatus according to still another aspect of the present disclosure includes the cleaning device, and a charging device that charges an image carrier by discharge from a discharge wire. The object to be cleaned is the discharge wire.

A cleaning method according to yet another aspect of the present disclosure is a cleaning method performed in an image forming apparatus which includes a cleaning mechanism that moves a cleaning member along an object to be cleaned, and a motor that drives the cleaning mechanism. The cleaning method includes: a cleaning control step of driving the motor with a predetermined driving voltage being applied to the motor, and stopping the driving of the motor after a predetermined driving time has elapsed; and a driving change step of changing one or both of the driving time and the driving voltage in accordance with change in the state of the object to be cleaned.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic configuration diagram of an image forming apparatus according to an embodiment of the present disclosure.

FIG. 2 is an external perspective view of a laser scanning unit according to the embodiment of the present disclosure.

FIG. 3 is a schematic plan view of a cleaning device for the laser scanning unit according to the embodiment of the present disclosure.

FIG. 4 is a schematic view of a main part of the cleaning device for the laser scanning unit according to the embodiment of the present disclosure.

FIG. 5 is a diagram showing an example of a procedure of a cleaning control process executed in the image forming apparatus according to the embodiment of the present disclosure.

FIG. 6 is a diagram showing an example of correspondence between driving time and elapsed time which is used in the cleaning control process executed in the image forming apparatus according to the embodiment of the present disclosure.

FIG. 7 is a diagram showing an example of correspondence between driving time and elapsed time which is used in the cleaning control process executed in the image forming apparatus according to the embodiment of the present disclosure.

### DETAILED DESCRIPTION

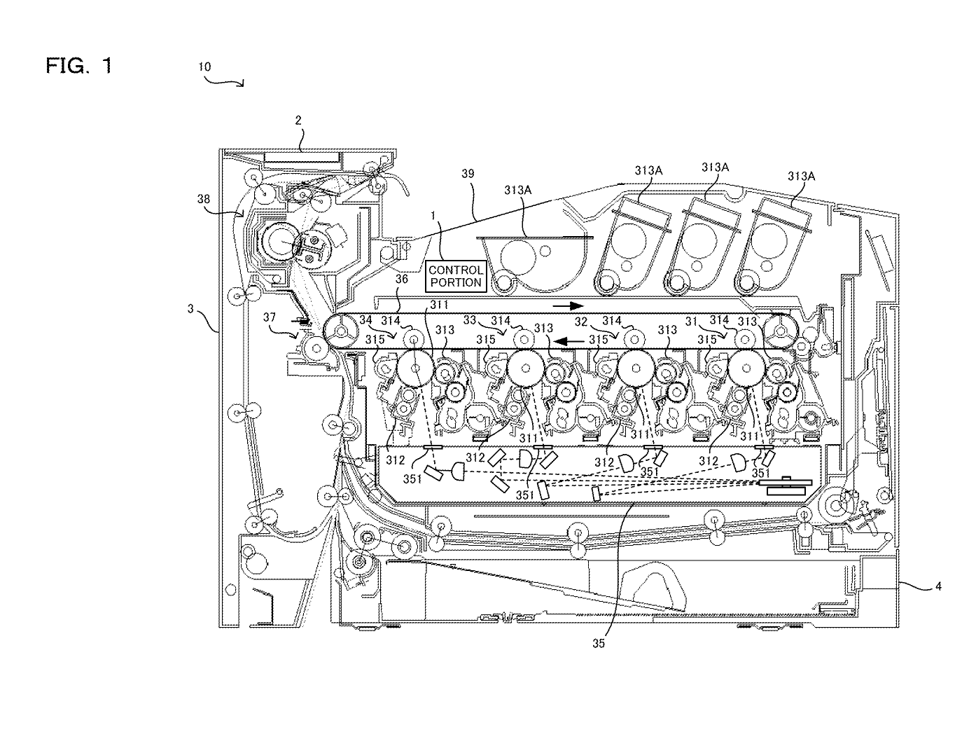

Hereinafter, a schematic configuration of an image forming apparatus 10 according to an embodiment of the present disclosure will be described with reference to FIG. 1. As shown in FIG. 1, the image forming apparatus 10 is a printer including a control portion 1, an operation display portion 2, an image forming portion 3, a sheet feed cassette 4, and the like. Other examples of the image forming apparatus according to the present disclosure include a facsimile apparatus, a copy machine, a multifunction peripheral, and the like.

The control portion 1 is a computer including control equipment such as a CPU, a ROM, a RAM, and an EEPROM. The CPU is a processor that executes various arithmetic processes. The ROM is a nonvolatile storage portion in which various pieces of information such as control programs for causing the CPU to execute the various processes are stored in advance. The RAM is a volatile storage portion, and the EEPROM is a nonvolatile storage portion. The RAM and the EEPROM are used as temporary storage memories (working areas) for the various processes executed by the CPU.

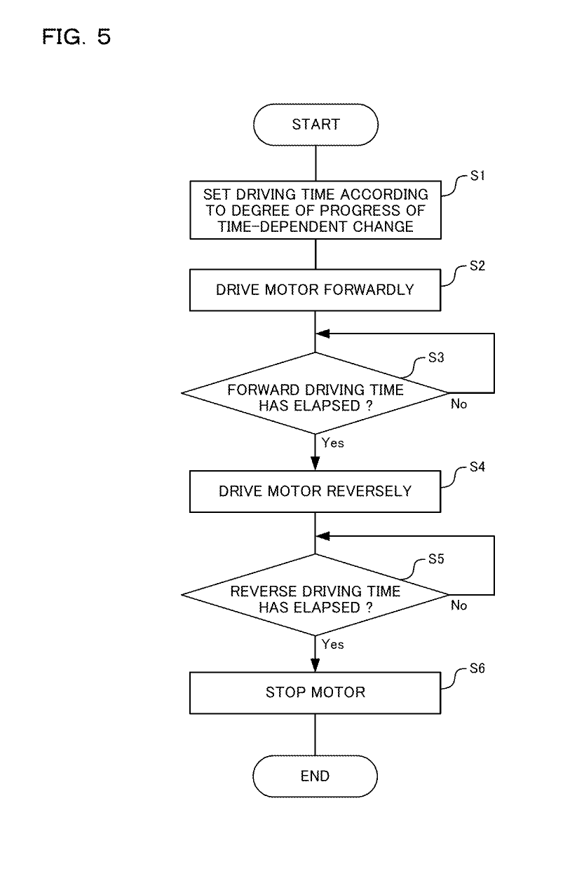

The control portion 1 executes, by the CPU, the various control programs stored in the ROM in advance, thereby performing overall control for the image forming apparatus 10. For example, the control portion 1 executes a cleaning control process described later (refer to FIG. 5). The control portion 1 may be formed of an electronic circuit such as an integrated circuit (ASIC or DSP). Alternatively, the control portion 1 may be an engine control portion provided in the image forming portion 3 or the like, separately from a main control portion that performs overall control for the image forming apparatus 10.

The operation display portion 2 includes a display portion such as a liquid crystal display that displays various kinds of information in accordance with control instructions from the control portion 1, and an operation portion such as hardware keys or a touch panel through which various kinds of information are input to the control portion 1 in accordance with user's operations.

The image forming portion 3 is an electrophotographic type image forming portion that forms an image on a sheet, based on image data input from an external information processing apparatus such as a personal computer. Specifically, the image forming portion 3 includes a plurality of image forming units 31 to 34, a laser scanning unit (LSU) 35, an intermediate transfer belt 36, a secondary transfer roller 37, a fixing device 38, a sheet discharge tray 39, and the like.

The image forming unit 31 corresponds to C (cyan), and the image forming unit 32 corresponds to M (magenta). The image forming unit 33 corresponds to Y (yellow), and the image forming unit 34 corresponds to K (black). The image forming units 31 to 34 each include a photosensitive drum 311, a charging device 312, a developing device 313, a primary transfer roller 314, a cleaning member 315, and the like.

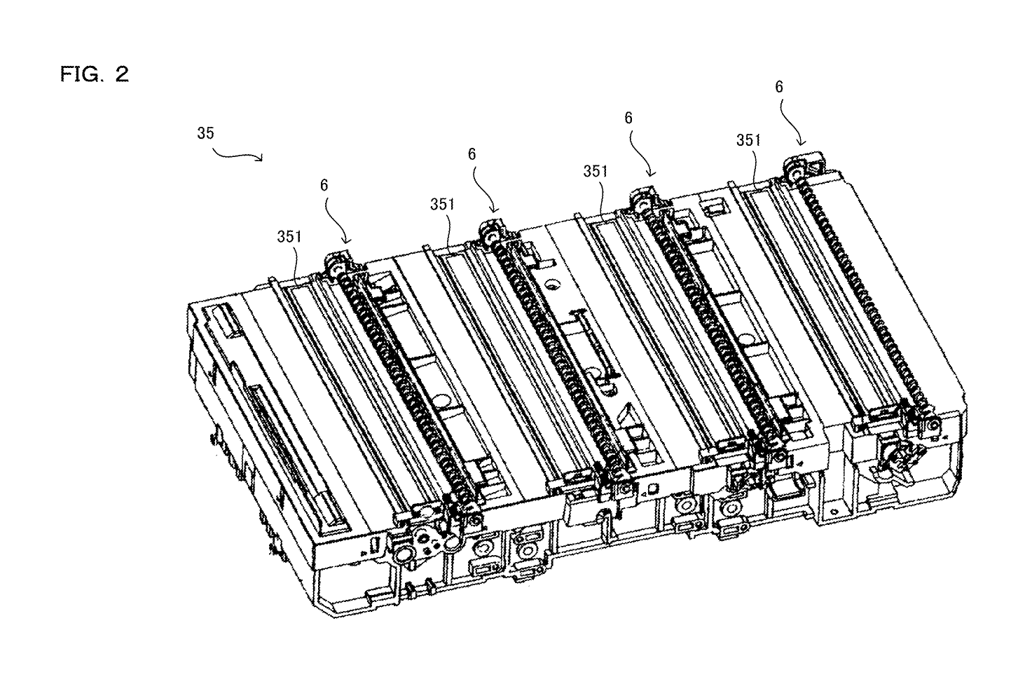

The laser scanning unit 35 emits laser light based on image data to each of the photosensitive drums 311 through each of light emitting windows 351 provided at an outer surface of a housing and having translucency, thereby forming an electrostatic latent image on each of the photosensitive drums 311. Further, the laser scanning unit 35 is provided with cleaning devices 6 (refer to FIG. 2) for cleaning the light emitting windows 351. The cleaning devices 6 will be described later in detail. That is, each light emitting window 351 is an example of an object to be cleaned. In the present embodiment, a device including the cleaning device 6 and the control portion 1 is an example of the cleaning device of the present disclosure. It is also conceivable that the cleaning devices 6 are provided with a control portion for executing a cleaning control process described later, separately from the control portion 1.

The image forming portion 3 executes an image forming process in the following procedure when being controlled by the control portion 1. First, in the image forming portion 3, the photosensitive drum 311 of each of the image forming units 31 to 34 is uniformly charged at a predetermined potential by the charging device 312. Next, the surface of each photosensitive drum 311 is irradiated with light based on image data corresponding to each color by the laser scanning unit 35, whereby an electrostatic latent image corresponding to each color is formed on the surface of each photosensitive drum 311. Then, the electrostatic latent image on each photosensitive drum 311 is developed (visualized) as a toner image of each color by the developing device 313. A toner (developer) is supplied to the developing device 313 from a toner container 313A corresponding to each color. Next, the toner images on the respective photosensitive drums 311 are sequentially transferred in an overlapping manner onto the intermediate transfer belt 36 by the primary transfer rollers 314, whereby a monochrome or color toner image is formed on the intermediate transfer belt 36. Next, the toner image on the intermediate transfer belt 36 is transferred onto a sheet fed from the sheet feed cassette 4 by the secondary transfer roller 37. Thereafter, the toner image formed on the sheet is melted and fixed on the sheet by the fixing device 38, and the sheet is discharged to the sheet discharge tray 39. In the case of monochrome printing, the image forming process is executed by using only the image forming unit 34.

[Cleaning Device 6]

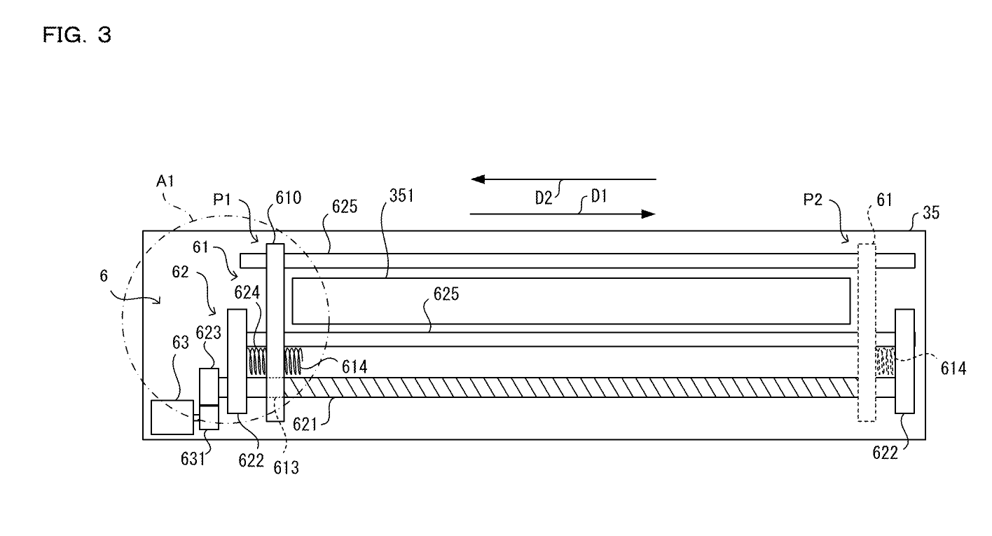

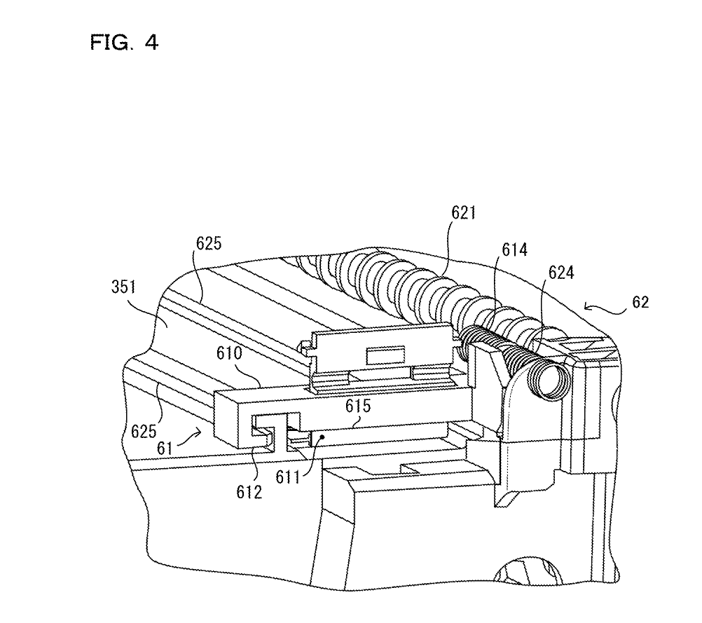

Hereinafter, the cleaning devices 6 mounted in the laser scanning unit 35 will be described with reference to FIGS. 2 to 4. FIG. 2 is an external perspective view of the laser scanning unit 35, FIG. 3 is a schematic plan view of each cleaning device 6, and FIG. 4 is a main part schematic diagram showing an enlarged view of a partial area A1 in FIG. 3.

As shown in FIG. 2, the cleaning devices 6 are provided for the respective light emitting windows 351 of the laser scanning unit 35. Since the cleaning devices 6 each have the same configuration, one of the cleaning devices 6 will be described hereinafter.

As shown in FIGS. 3 and 4, the cleaning device 6 includes a cleaning member 61, a cleaning mechanism 62, and a motor 63. Hereafter, the position of a left side end of the cleaning member 61 indicated by a solid line in FIG. 3 is referred to as a standby position P1, and the position of a right side end of the cleaning member 61 indicated by a dashed line in FIG. 3 is referred to as the other end position P2.

The cleaning member 61 includes a carriage 610, and a blade 611 attached to the carriage 610. The carriage 610 includes an engagement portion 612 engaged with a guide rail 625 described later, a connection portion 613 screwed with a screw shaft 621 described later, and a holder 615 that holds the blade 611. The cleaning mechanism 62 includes the screw shaft 621, bearings 622, an input gear 623, and a pair of guide rails 625. The motor 63 is a DC motor used as a driving source of the cleaning mechanism 62. An output gear 631 joined with a rotation shaft of the motor 63 meshes with the input gear 623. The motor 63 is a driving source shared by the cleaning devices 6, and a driving force of the motor 63 is input to the input gear 623 of each cleaning device 6 via a driving system (not shown). Alternatively, in another embodiment, the motor 63 may be individually provided for each cleaning device 6.

The blade 611 is formed of an elastic member such as silicone resin. The blade 611 moves while being in contact with the light emitting window 351 to rub the light emitting window 351, thereby cleaning the light emitting window 351. The pair of guide rails 625 are provided in parallel to each other along the longitudinal direction of the light emitting window 351. The engagement portion 612 is engaged with one of the guide rails 625 to slidably support the cleaning member 61 in the longitudinal direction of the light emitting window 351. The cleaning member 61 further includes an engagement portion (not shown) that is engaged with the other guide rail 625 to slidably support the cleaning member 61 in the longitudinal direction of the light emitting window 351. An internal screw thread to be engaged with the screw shaft 621 of the cleaning mechanism 62 is formed in an inner surface of an aperture of the connection portion 613, and the screw shaft 621 is fitted in the connection portion 613.

The screw shaft 621 is a conveyance shaft (ball screw) that is arranged in parallel to the longitudinal direction of the light emitting window 351, and is pivotably supported by the bearings 622. An external screw thread to be engaged with the connection portion 613 of the cleaning member 61 is formed in an outer circumferential surface of the screw shaft 621. Further, the input gear 623 provided at an end of the screw shaft 621 meshes with the output gear 631 of the motor 63. The input gear 623 transfers the driving force of the motor 63 to the screw shaft 621 to rotate the screw shaft 621.

When the screw shaft 621 is driven to rotate by the motor 63, the screw shaft 621 causes the cleaning member 61 to move in a forward direction D1 from the standby position P1 to the other end position P2 or in a backward direction D2 from the other end position P2 to the standby position P1. In this way, in the cleaning device 6, the cleaning mechanism 62 is driven by the motor 63, and the blade 611 of the cleaning member 61 is moved along the light emitting window 351, whereby the light emitting window 351 is cleaned. Hereinafter, driving of the motor 63 when the cleaning member 61 is moved in the forward direction D1 is referred to as forward driving, and driving of the motor 63 when the cleaning member 61 is moved in the backward direction D2 is referred to as reverse driving.

Further, the screw shaft 621 has a predetermined non-conveyance region where no external screw thread is formed, which is provided inward with respect to each bearing 622. Thereby, after the cleaning member 61 has been conveyed to the non-conveyance region on the other end position P2 side by forward driving of the motor 63, movement of the cleaning member 61 in the forward direction D1 is restricted. Likewise, after the cleaning member 61 has been conveyed to the non-conveyance region on the standby position P1 side by reverse driving of the motor 63, movement of the cleaning member 61 in the backward direction D2 is restricted.

On the other hand, the cleaning member 61 has a spring 614. The spring 614 is fixed to a wall of the cleaning member 61. When the cleaning member 61 is moved to the bearing 622 on the other end position P2 side, the spring 614 comes in contact with the wall of the bearing 622 to press the cleaning member 61 in the backward direction D2. Thereby, even if forward driving of the motor 63 is continued after the cleaning member 61 has reached the other end position P2, the threadably engaged state between the connection portion 613 of the cleaning member 61 and the screw shaft 621 is maintained after the motor 63 is stopped. Therefore, when the motor 63 is then reversely driven, the cleaning member 61 moves in the backward direction D2.

Likewise, the cleaning mechanism 62 has a spring 624. The spring 624 is fixed to a wall of the bearing 622 on the standby position P1 side. When the cleaning member 61 has moved to the bearing 622 on the standby position P1 side, the spring 624 comes in contact with the cleaning member 61 to press the cleaning member 61 in the forward direction D1. Thereby, even if reverse driving of the motor 63 is continued after the cleaning member 61 has reached the standby position P1, the threadably engaged state between the connection portion 613 of the cleaning member 61 and the screw shaft 621 is maintained after the motor 63 is stopped. Therefore, when the motor 63 is then forwardly driven, the cleaning member 61 moves in the forward direction D1.

In the cleaning device 6, driving of the motor 63 is controlled by the control portion 1, and the cleaning member 61 moves in the forward direction D1 and the backward direction D2 with the blade 611 being in contact with the light emitting window 351, thereby cleaning the light emitting window 351. More specifically, the control portion 1 executes a cleaning control process described later, whereby the motor 63 is forwardly driven for a predetermined forward driving time and then reversely driven for a predetermined reverse driving time, and thereafter, driving of the motor 63 is stopped. That is, the control portion 1 stops the motor 63 after a predetermined driving time including the forward driving time and the reverse driving time has elapsed after start of driving of the motor 63, thereby ending the series of cleaning operations by the cleaning device 6. The above-mentioned process is an example of a cleaning control step, and the control portion 1 executing the cleaning control step is an example of a cleaning control portion. Each of the forward driving time and the reverse driving time is a time previously set as a time required for the cleaning member 61 to move between the standby position P1 and the other end position P2, and is half the above-mentioned driving time, for example. Thus, in the image forming apparatus 10, the cleaning operation of the cleaning device 6 is controlled by the driving time of the motor 63, and therefore, a sensor for detecting that the cleaning member 61 has reached the standby position P1 and the other end position P2 can be dispensed with.

However, if the surface resistance of the light emitting window 351 increases according to time-dependent change of the laser scanning unit 35, the coefficient of friction between the blade 611 of the cleaning member 61 and the light emitting window 351 increases. Thereby, the load on the motor 63 that causes the cleaning member 61 to move is increased, and the revolution speed of the motor 63 is reduced to reduce the moving speed of the cleaning member 61. Therefore, if the driving time of the motor 63 for one cleaning operation of the cleaning device 6 is always constant, the cleaning member 61 might stop in the middle of the cleaning path starting from the standby position P1 and returning to the standby position P1 through the other end position P2. On the other hand, if the driving time is sufficiently long, the waiting time during which a user cannot use the image forming apparatus 10 because of the cleaning operation is wastefully increased. Further, if the laser scanning unit 35 does not include the non-conveyance region of the screw shaft 621, the spring 614, and the spring 624, driving of the motor 63 is continued after the cleaning member 61 has reached the standby position P1 or the other end position P2, and the motor 63 might be damaged due to overload. In contrast, in the image forming apparatus 10, the driving time of the motor 63 can be changed by the control portion 1. More specifically, in the image forming apparatus 10, since the control portion 1 executes the later-described cleaning control process, the cleaning member 61 is prevented from being stopped in the middle of the cleaning path, and wasteful driving time of the cleaning member 61 is reduced. Accordingly, in the image forming apparatus 10, it is possible to realize both prevention of occurrence of the above-mentioned waiting time and prevention of damage on the motor 63.

[Cleaning Control Process]

Hereinafter, an example of a procedure of a cleaning control process to be executed by the control portion 1 will be described with reference to a flowchart shown in FIG. 5. In FIG. 5, S1, S2, . . . represent the numbers of steps in the procedure executed by the control portion 1.

In the image forming apparatus 10, the cleaning control process is executed by the control portion 1 every time a predetermined period of time has elapsed or every time a predetermined number of sheets have been printed and output. Alternatively, the cleaning control process may be executed when the image forming apparatus 10 is powered on, or when the image forming apparatus 10 is restored from an energy saving mode. Further, it is also conceivable that the cleaning control process is executed when the photosensitive drum 311 or the toner container 313A of the image forming portion 3 is replaced.

<Step S1>

In step S1, the control portion 1 sets a driving time of the motor 63 of the cleaning device 6 in accordance with change in the state of the light emitting window 351. In particular, the control portion 1 determines the degree of progress of time-dependent change of the light emitting window 351 as the change in the state of the light emitting window 351, and increases the driving time of the motor 63 in accordance with the progress of the time-dependent change. Here, step S1 in which the driving time is changed according to the change in the state of the light emitting window 351 is an example of a driving change step, and the control portion 1 executing step S1 is an example of a determination portion and a drive changing portion. By the way, the change in the state of the light emitting window 351 is, for example, modification of a glass surface of the light emitting window 351 caused by a chemical change due to water vapor or the like attached to the light emitting window 351, or contamination of the light emitting window 351. The control portion 1 may change the driving time in accordance with a user's operation to the operation display portion 2.

Specifically, when the image forming apparatus 10 is initially activated, the control portion 1 stores, in the EEPROM, as elapsed time information, the date of the initial activation, that is, the date when use of the image forming apparatus 10 is started. The start-of-use date is, for example, date and time that is input to the control portion 1 in accordance with a user's operation performed to the operation display portion 2 at the initial activation, or date and time counted by a clock function included in the control portion 1, or reference date and time acquired by the control portion 1 from a system clock included in an information processing apparatus such as a personal computer connected via a network or the like. Thereafter, in step S1, the control portion 1 calculates, based on the elapsed time information, the time (the number of days) elapsed from the start-of-use date to the current time, as information indicating the degree of progress of time-dependent change of the light emitting window 351. Then, in step S1, the control portion 1 sets the driving time of the motor 63 in accordance with the degree of progress of time-dependent change of the light emitting window 351. The control portion 1 can reset the degree of progress of time-dependent change of the light emitting window 351 in accordance with a user's operation input to the operation display portion 2 when the laser scanning unit 35 is replaced or when the light emitting window 351 is replaced.

The longer the elapsed time is, the more the control portion 1 increases the driving time of the motor 63. The relationship between the elapsed time and the driving time is previously set based on an experimental result or the like such that the driving time is set as a time during which the cleaning member 61 can make a reciprocating motion between the standby position P1 and the other end position P2 when time-dependent change of the light emitting window 351 corresponding to the elapsed time occurs. At this time, the control portion 1 increases the forward driving time and the reverse driving time, included in the driving time, each by the same period of time. It is also conceivable that the control portion 1 increases the forward driving time and the reverse driving time by different periods of time so as to make one of these times longer than the other. Alternatively, in another embodiment, the control portion 1 may increase only one of the forward driving time and the reverse driving time.

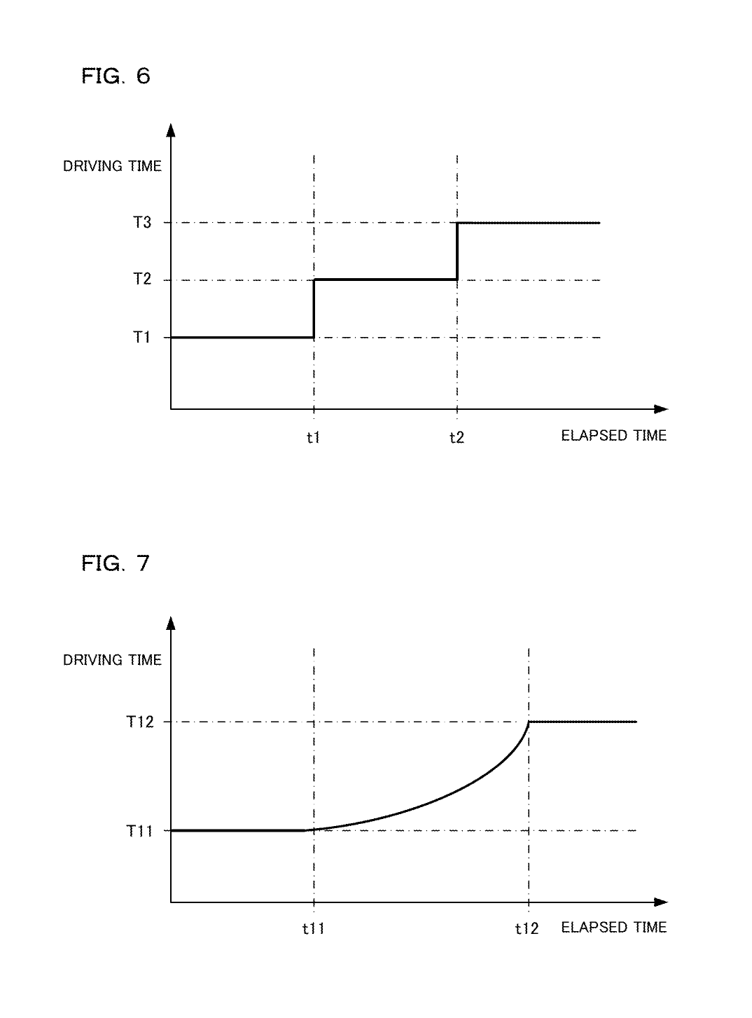

FIGS. 6 and 7 are graphs showing examples of the relationship between the elapsed time and the driving time. FIG. 6 shows an example in which the driving time is increased stepwise every time the elapsed time increases by a predetermined period of time. More specifically, in the example shown in FIG. 6, the control portion 1 sets the driving time to T1 until the elapsed time reaches t1. When the elapsed time has reached t1, the control portion 1 increases the driving time by a predetermined value to set the driving time to T2. Thereafter, when the elapsed time has increased by the predetermined period of time and reached t2, the control portion 1 increases the driving time by the predetermined value to set the driving time to T3. At this time, the control portion 1 sets a time corresponding to half the driving time as each of the forward driving time and the reverse driving time.

On the other hand, FIG. 7 shows an example in which the driving time changes in a quadratic curve (a parabola) that gradually increases with increase in the elapsed time. More specifically, in the example shown in FIG. 7, the control portion 1 sets the driving time to T11 until the elapsed time reaches t11, and thereafter, sets the driving time to a value that increases in a quadratic curve with increase in the elapsed time. When the elapsed time has reached t12, the control portion 1 sets the driving time to T12 that is unchanged thereafter. In other words, the driving time is increased with T12 being the upper limit value thereof. The relationship between the elapsed time and the driving time is not limited to the relationships mentioned above. In another embodiment, the driving time may be linearly increased with increase in the elapsed time.

<Steps S2 and S3>

In step S2, the control portion 1 applies a predetermined driving voltage to the motor 63 to start forward driving of the motor 63, thereby moving the cleaning member 61 in the forward direction D1. Thereafter, in step S3, the control portion 1 waits for the elapse of the forward driving time from the start of driving of the motor 63. Upon determining that the forward driving time has elapsed (Yes in step S3), the control portion 1 shifts the process to step S4. Until the forward driving time elapses (No in step S3), the control portion 1 causes the process to wait in step S3.

At this time, in the image forming apparatus 10, in step S1, the forward driving time is set according to the progress of time-dependent change of the light emitting window 351. In particular, in step S1, the forward driving time is extended according to the progress of time-dependent change of the light emitting window 351. Therefore, even if the load on the motor 63 is increased due to increase in the surface resistance of the light emitting window 351 and thereby the revolution speed of the motor 63 is reduced, it is possible to move the cleaning member 61 from the standby position P1 to the other end position P2 without stopping the cleaning member 61 in the middle of the path.

<Steps S4 and S5>

Subsequently, in step S4, the control portion 1 stops the motor 63, and thereafter, applies the driving voltage the polarity of which is inverted to the motor 63 to start reverse driving of the motor 63, thereby moving the cleaning member 61 in the backward direction D2. Thereafter, in step S5, the control portion 1 waits for the elapse of the reverse driving time from the start of driving of the motor 63. Upon determining that the reverse driving time has elapsed (Yes in step S5), the control portion 1 shifts the process to step S6. Until the reverse driving time elapses (No in step S5), the control portion 1 causes the process to wait in step S5.

At this time, in the image forming apparatus 10, the reverse driving time is set in step S1 according to the progress of time-dependent change of the light emitting window 351. In particular, in step S1, the reverse driving time is extended according to the progress of time-dependent change of the light emitting window 351. Therefore, even if the load on the motor 63 is increased due to increase in the surface resistance of the light emitting window 351 and thereby the revolution speed of the motor 63 is reduced, it is possible to move the cleaning member 61 from the other end position P2 to the standby position P1 without stopping the cleaning member 61 in the middle of the path.

<Step S6>

Thereafter, in step S6, the control portion 1 stops the motor 63 to end the series of cleaning operations. In the present embodiment, a reciprocating motion of the cleaning member 61 in the forward direction D1 and the backward direction D2 is described as one cycle of cleaning operation. Alternatively, one cycle of cleaning operation may be a motion of the cleaning member 61 in the forward direction D1 or the backward direction D2 by forward driving or reverse driving of the motor 63 for a predetermined driving time, respectively.

As described above, in the image forming apparatus 10, when the cleaning control process is executed by the control portion 1, the driving time (forward driving time and the reverse driving time) is gradually extended according to the progress of time-dependent change of the light emitting window 351. Accordingly, even if the surface resistance of the light emitting window 351 is increased due to the time-dependent change, it is possible to prevent the cleaning member 61 from stopping in the middle of the cleaning operation. Further, in the image forming apparatus 10, since the driving time need not be secured to be long from the beginning, it is possible to reduce wasteful driving time of the cleaning member 61. For example, in the image forming apparatus 10, user's wasteful waiting time is reduced when the light emitting window 351 does not change over time. Further, in the image forming apparatus 10, it is possible to reduce the time during which driving of the motor 63 is continued after the cleaning member 61 has reached the standby position P1 or the other end position P2, and therefore, overload on the motor 63 can be avoided.

By the way, the elapsed time information is not limited to the start-of-use date of the image forming apparatus 10, and any information may be used as long as the degree of progress of time-dependent change of the light emitting window 351 can be estimated from the information. For example, it is conceivable that the elapsed time information is the production date of the light emitting window 351, and the control portion 1 increases the driving time in accordance with increase in the elapsed time from the production date of the light emitting window 351 to the current time. The production date of the laser scanning unit 35 may be regarded as the production date of the light emitting window 351. For example, it is conceivable that when the image forming apparatus 10 is assembled, the production date of the laser scanning unit 35 is read from a barcode affixed to the laser scanning unit 35 by using a barcode reader (not shown) connectable to the image forming apparatus 10. Alternatively, it is also conceivable that the control portion 1 specifies the degree of progress of time-dependent change of the laser scanning unit 35, based on the elapsed time information such as the production date of the laser scanning unit 35 or the start-of-use date of the image forming apparatus 10, which is input by an operation performed on the operation display portion 2 or the like. Further, it is also conceivable that the control portion 1 acquires the count number of printed sheets in the image forming apparatus 10 as the elapsed time information, and specifies the degree of progress of time-dependent change of the laser scanning unit 35 in accordance with the count number.

Furthermore, in the present embodiment, the case of changing the driving time has been described as an example. Alternatively, the torque of the motor 63 may be increased by increasing the driving voltage applied to the motor 63 when the motor 63 is driven. Thereby, even when the light emitting window 351 changes over time, the cleaning member 61 can be prevented from stopping in the middle of the cleaning operation, without changing the driving time. Therefore, it is conceivable, as another embodiment, that the control portion 1 in step S1 increases the driving voltage applied to the motor 63 in accordance with the progress of the time-dependent change. Further, it is also conceivable that the control portion 1 increases both the driving time of the motor 63 and the driving voltage of the motor 63 in accordance with the progress of the time-dependent change. A conventionally known boosting circuit or the like may be used to increase the driving voltage applied to the motor 63.

Furthermore, when the image forming apparatus 10 is equipped with a temperature/humidity sensor for detecting environmental temperature or humidity, the control portion 1 can recognize the use environment of the image forming apparatus 10 based on the environmental temperature or humidity detected by the temperature/humidity sensor. Therefore, it is conceivable that the control portion 1 specifies the degree of time-dependent change of the light emitting window 351 of the laser scanning unit 35, based on the detection result of the temperature/humidity sensor. For example, when the environment humidity detected by the temperature/humidity sensor is higher than a predetermined threshold, the control portion 1 determines that the progress of time-dependent change of the light emitting window 351 is rapid, and increases the amount of change of the driving time with respect to the change of the elapsed time.

Furthermore, in the image forming apparatus 10, it is conceivable that the control portion 1 executes the cleaning control process for another cleaning device whose cleaning operation is controlled based on the driving time, like the cleaning device 6. Specifically, a case is considered in which the charging device 312 of the image forming portion 3 is a corona discharge type charging device that charges the photosensitive drum 311 (image carrier), in a non-contact manner, by discharge from a discharge wire. In this case, foreign matter may attach to the discharge wire, or the discharge wire may be oxidized. Therefore, the charging device 312 may be provided with a cleaning device that cleans the discharge wire with a cleaning member being moved along the discharge wire. That is, the discharge wire is an example of an object to be cleaned. So, like the above-mentioned cleaning control process, it is conceivable that the control portion 1 changes one or both of the driving time and the driving voltage of the motor for driving the cleaning member of the cleaning device for the discharge wire in accordance with change in the state of the discharge wire. More specifically, it is conceivable that the control portion 1 increases one or both of the driving time and the driving voltage in accordance with the progress of time-dependent change of the discharge wire. Therefore, it is possible to prevent the cleaning member from stopping in the middle of the cleaning operation, and reduce wasteful driving time of the cleaning member, while a sensor for detecting the position of the cleaning member is dispensed with.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A cleaning device provided in an image forming apparatus, and configured to clean an object to be cleaned, the cleaning device comprising:
a cleaning member configured to slide along the object to be cleaned;
a cleaning mechanism configured to cause the cleaning member to slide along the object to be cleaned;
a motor configured to drive the cleaning mechanism;
a cleaning control portion configured to drive the motor with a predetermined driving voltage being applied to the motor, and to stop the driving of the motor after a predetermined driving time has elapsed; and
a driving change portion configured to be able to change one or both of the driving time and the driving voltage.

2. The cleaning device according to claim 1, further comprising:
a determination portion configured to determine a degree of progress of change in the state of the object to be cleaned, wherein
the driving change portion, based on a result of determination made by the determination portion, changes one or both of the driving time and the driving voltage in accordance with the change in the state of the object to be cleaned.

3. The cleaning device according to claim 2, wherein
the determination portion determines the degree of progress of time-dependent change of the object to be cleaned, as the change in the state of the object to be cleaned, and
the driving change portion, based on the result of determination made by the determination portion, increases one or both of the driving time and the driving voltage in accordance with the progress of time-dependent change of the object to be cleaned.

4. The cleaning device according to claim 3, wherein
the determination portion determines the degree of progress of time-dependent change of the object to be cleaned, in accordance with any of a start-of-use date of the image forming apparatus, the number of printed sheets in the image forming apparatus, and a production date of the object to be cleaned.

5. The cleaning device according to claim 3, wherein
the cleaning mechanism causes the cleaning member to make a reciprocating motion in accordance with forward driving and reverse driving of the motor,
the cleaning control portion drives the motor forwardly until a predetermined forward driving time elapses, and thereafter, drives the motor reversely until a predetermined reverse driving time elapses, and then stops the driving of the motor, and
the driving change portion increases one or both of the forward driving time and the reverse driving time.

6. An image forming apparatus comprising:
the cleaning device according to claim 1; and
a laser scanning unit configured to emit light to a photosensitive drum through a light emitting window provided at an outer surface of a housing and having transparency, wherein
the object to be cleaned is the light emitting window.

7. An image forming apparatus comprising:
the cleaning device according to claim 2; and
a laser scanning unit configured to emit light to a photosensitive drum through a light emitting window provided at an outer surface of a housing and having transparency, wherein
the object to be cleaned is the light emitting window.

8. An image forming apparatus comprising:
the cleaning device according to claim 3; and
a laser scanning unit configured to emit light to a photosensitive drum through a light emitting window provided at an outer surface of a housing and having transparency, wherein
the object to be cleaned is the light emitting window.

9. An image forming apparatus comprising:
the cleaning device according to claim 4; and
a laser scanning unit configured to emit light to a photosensitive drum through a light emitting window provided at an outer surface of a housing and having transparency, wherein
the object to be cleaned is the light emitting window.

10. An image forming apparatus comprising:
the cleaning device according to claim 5; and
a laser scanning unit configured to emit light to a photosensitive drum through a light emitting window provided at an outer surface of a housing and having transparency, wherein
the object to be cleaned is the light emitting window.

11. An image forming apparatus comprising:
the cleaning device according to claim 1; and
a charging device configured to charge an image carrier by discharge from a discharge wire, wherein
the object to be cleaned is the discharge wire.

12. An image forming apparatus comprising:
the cleaning device according to claim 2; and
a charging device configured to charge an image carrier by discharge from a discharge wire, wherein
the object to be cleaned is the discharge wire.

13. An image forming apparatus comprising:
the cleaning device according to claim 3; and
a charging device configured to charge an image carrier by discharge from a discharge wire, wherein
the object to be cleaned is the discharge wire.

14. An image forming apparatus comprising:
the cleaning device according to claim 4; and
a charging device configured to charge an image carrier by discharge from a discharge wire, wherein
the object to be cleaned is the discharge wire.

15. An image forming apparatus comprising:
the cleaning device according to claim 5; and
a charging device configured to charge an image carrier by discharge from a discharge wire, wherein
the object to be cleaned is the discharge wire.

16. A cleaning method performed in an image forming apparatus which includes a cleaning mechanism that moves a cleaning member along an object to be cleaned, and a motor that drives the cleaning mechanism, the cleaning method comprising:
a cleaning control step of driving the motor with a predetermined driving voltage being applied to the motor, and stopping the driving of the motor after a predetermined driving time has elapsed; and
a driving change step of changing one or both of the driving time and the driving voltage in accordance with change in the state of the object to be cleaned.
